(19) United States
(12) Patent Application Publication
(10) Pub. No.: US 2002/0072971 A1
(43) Pub. Date: Jun. 13, 2002

(54) Targeting electronic advertising placement in accordance with an analysis of user inclination and affinity

(76) Inventors: David DeBusk, Seattle, WA (US); Kevin Hillstrom, Seattle, WA (US); Will Medford, Seattle, WA (US); Vladimir Victorovich Schipunov, Seattle, WA (US); Mark Smucker, Seattle, WA (US); Young Bean Song, Seattle, WA (US); Michael E. Wolf, Seattle, WA (US); Chen Yu, Mountain View, WA (US)

Correspondence Address: PERKINS COIE LLP, PATENT-SEA, P.O. BOX 1247, SEATTLE, WA, 98111-1247, US

(21) Appl. No.: 09/880,724

(22) Filed: Jun. 12, 2001

Related U.S. Application Data
(63) Continuation-in-part of application No. 09/702,004, filed on Oct. 30, 2000.
(60) Provisional application No. 60/167,060, filed on Nov. 22, 1999.

(51) Int. Cl. G06F 17/60; G06F 15/173

(52) U.S. Cl. 705/14; 705/10; 709/224

(57) ABSTRACT

A facility for selecting advertising outlets on which to place advertising messages for an advertiser is described. For each of a first group of advertising outlets, the facility assesses the rate at which visitors to the advertiser also visit the advertising outlet. The facility selects an advertising outlet among the first group having the highest assessed rate. For each of a second group of advertising outlets, the facility assesses the tendency of a high-performing advertising outlet to drive its visitors to the advertising outlet among the second group of advertising outlets. The facility selects an advertising outlet among the second group to which the high-performing advertising outlet has the greatest assessed tendency to drive its visitors.

### CROSS REFERENCE TO RELATED APPLICATION

This application is a continuation-in-part of U.S. application Ser. No. No. 09/702,004 filed Oct. 30, 2000, which claims the benefit of U.S. Provisional Patent Application No. 60/167,060 filed Nov. 22, 1999, both of which are hereby incorporated by reference.

### TECHNICAL FIELD

The present invention is directed to electronic advertising techniques.

### BACKGROUND

As computer use, and particularly the use of the World Wide Web, becomes more and more prevalent, the volumes of Internet advertising presented grow larger and larger. As part of this growth, the number of Internet publishers on which it is possible to purchase advertising space for Internet advertising is rapidly expanding. As the number of Internet publishers grows, it becomes increasingly important to successfully identify Internet publishers that provide an effective venue for the Internet advertising messages of particular advertisers.

Accordingly, a facility for more effectively targeting Internet advertising placement for an Internet advertiser to particular Internet publishers would have significant utility.

### BRIEF DESCRIPTION OF THE DRAWINGS

FIG. 1 is a high-level block diagram showing the environment in which the facility preferably operates.

### DETAILED DESCRIPTION

A software facility for identifying Internet publishers and other electronic publishers on which to place advertising messages for particular advertisers using an assessment of user inclination and affinity is provided. In order to identify publishers on which to place advertising messages of an advertiser, the facility determines which of the publishers' web sites are commonly visited by visitors to the advertiser's web site. In particular, the facility does so by assessing a metric, called user inclination, that reflects the percentage of users observed to visit both the publisher web site and the advertiser's web site. The facility preferably uses this inclination metric, and/or variations thereon, to select Internet publishers upon which to place advertising messages for the advertiser. Variations on the inclination metric used by the facility include those that measure the percentage of visitors to a publisher's web site that also perform a selected set of actions on the advertiser's web site. This set of actions is typically selected for each advertiser based on aspects of the advertiser's web site and/or business. The facility preferably also performs an analysis to identify additional “affinity publishers” that are heavily visited by visitors to publisher web sites that have proven to have a high return on investment for the advertiser in question.

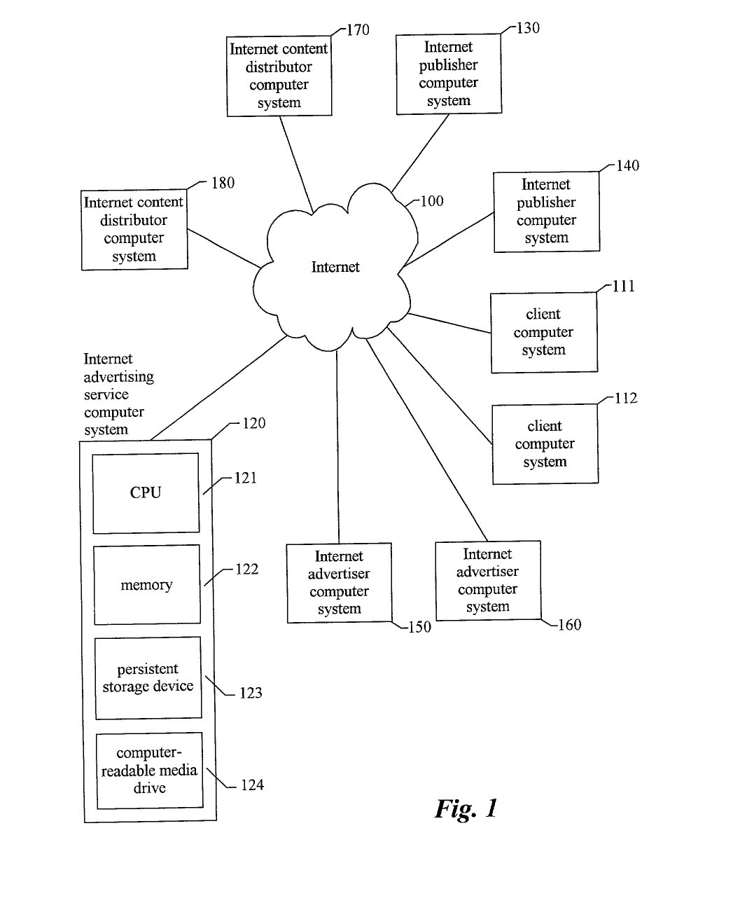

FIG. 1 is a high-level block diagram showing the environment in which the facility preferably operates. The diagram shows a number of Internet user computer systems 101-104. An Internet user preferably uses one such Internet user computer system to connect, via the Internet 120, to an Internet publisher computer system, such as Internet publisher computer systems 131 and 132, to retrieve and display a Web page. The term “Internet publisher” refers to individuals and organizations that make web pages accessible via the World Wide Web, and, in particular, those that sell the opportunity to advertise in some manner (“advertising space”) on those web pages.

In cases where an Internet advertiser, through the Internet advertising service, has purchased advertising space on the Web page provided to the Internet user computer system by the Internet publisher computer system, the Web page contains a reference to a URL in the domain of the Internet advertising service computer system 140. When a user computer system receives a Web page that contains such a reference, the Internet user computer systems sends a request to the Internet advertising service computer system to return data comprising an advertising message, such as a banner advertising message. When the Internet advertising service computer system receives such a request, it selects an advertising message to transmit to the Internet user computer system in response the request, and either itself transmits the selected advertising message or redirects the request containing an identification of the selected advertising message to an Internet content distributor computer system, such as Internet content distributor computer systems 151 and 152. When the Internet user computer system receives the selected advertising message, the Internet user computer system displays it within the Web page.

The displayed advertising message preferably includes one or more links to Web pages of the Internet advertiser's Web site. When the Internet user selects one of these links in the advertising message, the Internet user computer system references the link to retrieve the Web page from the appropriate Internet advertiser computer system, such as Internet advertiser computer system 161 or 162. The link to the web page of the Internet advertiser's web page is preferably processed through the Internet advertising service computer system 140 to permit the Internet advertising service computer system 140 to monitor the traversal of such links. In visiting the Internet advertiser's Web site, the Internet user may traverse several pages, and may take such actions as purchasing an item or bidding in an auction. Revenue from such actions typically finances, and is often the motivation for, the Internet advertiser's Internet advertising. In some embodiments, an advertiser may instrument particular web pages on its web site in a way that notifies the advertising service when a user visits that page of the advertiser's web site.

The Internet advertising service computer system 140 preferably includes one or more central processing units (CPUs) 141 for executing computer programs such as the facility, a computer memory 142 for storing programs and data, and a computer-readable media drive 143, such as a CD-ROM drive, for reading programs and data stored on a computer-readable medium. The Internet advertising service computer system preferably stores a log entry each time it processes a request to return an advertising message, a request to traverse a link to a web page of the Internet advertiser's web page, or notification that the user has visited a particular page of or completed some other action or actions on the Internet advertiser's web site. Each log entry preferably contains a user identifier identifying the user performing the noted action. In some embodiments, the user identifiers contained by log entries are collected by storing the user identifiers in a persistent “cookie” stored on the computer system of each user for the domain of the advertising service. Each time an HTTP request is transmitted from such a user to a web server in the domain of the advertising service, the user identifier stored in the cookie is included in the request.

In some embodiments, the facility performs its inclination and affinity analyses based on the contents of this stored log. In some embodiments, log entries covering a significant period of time, such as three months or six months, are used in the analyses. In some embodiments, only users that have seen advertising messages or triggered action tags over a period greater than 24 hours are used in the analyses. Additional similar filtering techniques may also be used. In other embodiments, the facility performs its inclination and/or affinity analyses based upon other data regarding user behavior, such as data gathered by observing the web traffic for a user and analyzing contents or other attributes of advertising messages appearing therein, or based upon data obtained from other sources.

The inclination metric measures where an advertiser naturally finds its customers, and is formally stated for a particular publisher as

p(visited advertiser/visited publisher):

the probability that a particular user who visited the publisher also visited the advertiser.

The inclination metric is calculated by dividing the number of unique users that visited the publisher in question and the home page of the advertiser (or another page of the advertiser's web site) by the number of unique users that visited the publisher in question. Table 1 below shows the inclination analysis for a sample advertiser named Garments.com.

TABLE 1
Inclination for Garments.com, December 1999

| | | # of user identifiers | |
|---|---|---|---|
| | | seen both at | |
| | unique user | publisher site and at | |
| | identifiers seen at | advertiser's home | |
| publisher | publisher | page | inclination |
| Sweater City | 50,000 | 1,000 | 2.0% |
| LittlePortal | 1,000,000 | 3,000 | 0.3% |
| BigPortal | 5,000,000 | 40,000 | 0.8% |

To perform the analysis, the facility selects a group of publishers with which the Internet advertising service has placed advertising messages. For example, the facility may select all of the publishers with which the Internet advertising service has placed advertising messages for any advertiser.

For each of these publishers, the facility identifies the number of different users, identified by unique user identifiers, that the Internet advertising service has observed visiting the publisher. This number is preferably obtained by reading the web server log for records indicating that an advertising message was displayed at the publisher to a user having a unique user identifier. In the example, the facility determines that 50,000 different users were observed visiting the Sweater City publisher.

The facility then determines, for each publisher, the number of unique user identifiers seen at the publisher that were also seen at the home page of the advertiser's web site. The facility preferably determines this number for each publisher by, for each of the unique user identifiers seen at the publisher's web site, determining whether the log contains a record indicating that a user having the same user identifier visited the advertiser's home page. In the example, the facility determines that, of the 50,000 different users observed to visit the Sweater City publisher's web site, 1,000 of these users were also seen at the advertiser's home page. The facility then determines the inclination level of visitors to each of the publishers toward the advertiser by dividing the number of user identifiers seen at the advertiser's home page over the total number of unique user identifiers seen at the publisher. In the example, the facility calculates an inclination of visitors to the Sweater City publisher's web site to the advertiser's home page of 2.0% by dividing 1,000 user identifiers seen at the advertiser's home page by 50,000 unique user identifiers seen at Sweater City. As is discussed in greater detail below, in some embodiments, the numerator of this fraction, rather than being the number of visitors to the publisher's web site that also visited the advertiser's home page, is instead be the number of visitors to the publisher's web site that also performed some selected set of actions on the advertiser's web site. In some embodiments, users must complete a selected set of actions on the publisher's web site to be included in the numerator or the denominator.

Since a publisher with high inclination is a web site where visitors to, and likely customers of, Garments.com tend to congregate, advertising at that publisher would seem to be likely to “hit” users who are natural Garments.com customers. In the above example, users who visit the Sweater City web site are users who like sweaters, and so visit Garments.com more than an average user. As advertising at Sweater City may be effective, the facility preferably favors purchasing advertising space for Garments.com from Sweater City over purchasing it from the other two publishers.

In some cases, inclination metrics determined as described above may be significantly biased, however. If the Internet advertising service had been presenting Garments.com advertising messages on BigPortal and not on LittlePortal, this would tend to increase the number of visitors to Garments.com that were also visitors to BigPortal relative to the number of visitors to Garments.com that were visitors to LittlePortal. In fact, if the advertiser had been advertising on AnotherPortal, and if a disproportionate number of users who visit AnotherPortal also visit BigPortal, then the BigPortal inclination would also appear fairly high. The high inclination is due, at least in part, to the BigPortal advertising campaign.

To remove this “advertising bias,” the facility in one embodiment uses a corrected measure of inclination called “pure inclination.” Pure inclination is the percentage of visitors to the publisher who have not seen an advertising message by the advertiser who visit the advertiser's web site. To determine pure inclination, the facility separates the unique user identifiers seen on each publisher into two groups: those who have seen one or more advertising messages for Garments.com, and those who have not. Table 2 below shows the pure inclination analysis for Garments.com.

TABLE 2
Pure Inclination for Garments.com, December 1999

| | | # of user identifiers | |
|---|---|---|---|
| | unique user | seen at publisher | |
| | identifiers visiting | that never saw an | |
| | publisher that never | advertising message | |
| | saw an advertising | for the advertiser | |
| | message for the | and at advertiser's | |
| publisher | advertiser | home page | pure inclination |
| Sweater City | 30,000 | 500 | 1.7% |
| LittlePortal | 900,000 | 2,500 | 0.3% |
| BigPortal | 4,000,000 | 16,000 | 0.4% |

Like the above-discussed determination of inclination, this determination of pure inclination indicates that Sweater City is a site where Garments.com visitors tend to congregate. This determination of pure inclination further indicates that advertising messages placed on LittlePortal and BigPortal would have almost the same advertising effectiveness for Garments.com.

If one publisher has higher pure inclination than another, there is significant reason to believe that the publisher with the higher pure inclination will respond to a campaign better than the other publisher, as users on the first publisher seem to be more inclined to the product than users who visit the second publisher. Accordingly, the facility preferably selects publishers at which to purchase space for future advertising messages for the advertiser on the basis of the pure inclinations of each publisher.

In some cases, advertiser web sites are heavily linked to related web sites. For example, some advertiser web sites are heavily linked to affiliate web sites, such as the web sites of companies that have common ownership with the advertiser, or that have other business relationships with the advertiser. In such cases, some embodiments of the facility also exclude from the pure inclination metric users that visited the publisher and saw an advertising message for a web site related to the advertiser web site.

In a variation of pure inclination used by the facility, pure inclination is determined by dividing the number of unique users visiting the publisher before they viewed an advertising message for the advertiser by the number of those users that visited the advertiser's home page.

The facility preferably also determines a third metric for analyzing the effectiveness of advertising on particular publishers for specific advertisers called “view inclination.” The facility determines view inclination by determining, of the unique user identifiers that have visited the publisher that have also seen an advertising message of the advertiser's, the percentage of those user identifiers seen at the advertiser's home page. Table 3 shows the calculation of view inclination for Garments.com.

TABLE 3
View Inclination for Garments.com, December 1999

| | | # of user identifiers | |
|---|---|---|---|
| | unique user | seen at publisher | |
| | identifiers visiting | that have seen an | |
| | publisher that have | advertising message | |
| | seen an advertising | of the advertiser's | |
| | message of the | and at advertiser's | view |
| publisher | advertiser's | home page | inclination |
| Sweater City | 20,000 | 500 | 2.5% |
| LittlePortal | 100,000 | 500 | 0.5% |
| BigPortal | 1,000,000 | 24,000 | 2.4% |

The facility preferably also uses a fourth metric to measure the effectiveness of advertising performed for the advertiser, called “comparative inclination.” To determine comparative inclination, the facility preferably subtracts the pure inclination for each publisher from the view inclination for that publisher. A calculation of comparative inclination for the example is shown below in Table 4.

TABLE 4
Comparative Inclination for Garments.com, December 1999

| | | | Comparative |
|---|---|---|---|
| Publisher | View Inclination | Pure Inclination | Inclination |
| Sweater City | 2.5% | 1.7% | .8% |
| LittlePortal | .5% | .3% | .2% |
| BigPortal | 2.4% | .4% | 2.0% |

It can be seen in Table 4 that advertising messages presented on BigPortal are likely to be significantly more effective than advertising messages presented on the other two publishers.

In some embodiments, the facility enables a user to select a set of actions that users must complete on the advertiser's web site in order to be counted in the numerator of various versions of the inclination metric, thereby targeting publisher web sites frequented by users completing that set of actions. Selecting such a set of actions may serve a variety of purposes. A first such purpose is identifying classes of new users that the advertiser would like to use advertising to attract to its web site. As an example, the advertiser may select a set of actions that collectively representing buying a minimum number of products at the advertiser's web site, thus targeting users like those that purchase several items to receive advertising messages designed to attract new users.

A second such purpose is identifying classes of existing users of the advertiser's web site whose use of the advertiser's web site the advertiser would like to modify using advertising. As an example, the advertiser may select a set of actions that collectively represent selecting a product for purchase, but not completing the purchase, thus targeting users that need additional encouragement or incentive to become paying customers to receive advertising messages that provide such encouragement (e.g., an enumeration of the benefits of purchasing from the advertiser) or incentive (e.g., an electronic coupon).

Additional examples of sets of actions include: visiting the advertiser's web site on 5 or more different days; purchasing more than $500 worth of products; visiting the advertiser's web site for more than 20 minutes; visited a product detail page on the advertiser's web site; etc. An action set may specify that a single action be performed, that each of a number of actions be performed, that any of a number of actions be performed, that certain actions be performed in a particular sequence, or more complicated combinations of the preceding.

A more involved use of action sets is to use different action sets to divide users visiting the publisher web sites into two or more segments, then use inclination analysis to select publishers on which to present different advertising messages to members of each of these segments. As an example, action sets may be specified that divide visitors to the advertiser's site into a first segment whose members purchased products from the advertiser only in a single product category, and a second segment whose members have purchased products from the advertiser in multiple product categories. Inclination analysis is applied to identify a first group of publishers commonly visited by members of the first segment, and to identify a second group of publishers commonly visited by members of the second segment. A first advertising message, designed to attract new members likely to buy from multiple segments, is then presented at the first group of publishers, while a second advertising message, designed to persuade members of the second segment to purchase from additional categories, is presented at the second group of publishers.

Action sets like those discussed above may be specified in a variety of ways. In a first way, someone knowledgeable about the advertiser's business goals and web site specifies an action set by writing procedural code that checks web server logs and/or other sources for information about user actions on the advertiser's web site for users that have performed the actions of the action set. In a second way, such a person instead fills out a form or uses another type of user interface-such as a dialog box or a wizard—to specify the action set. The resulting action set may be stored in a variety of data structures, transmitted from one computer system to another, and applied to perform inclination analysis.

In some embodiments, users are selected in various other ways for inclusion in the numerator of various versions of the inclination metric. Such selection may be based upon virtually any information available about the user, including the demographic groups to which the user belongs, the web browsing patterns exhibited by the user, the tendencies of the user to respond to particular kinds of advertising messages, the transaction history of the user, etc.

In addition to using one or more forms of inclination to identify Internet publishers on which to place advertisements for a particular advertiser, the facility preferably also uses an affinity analysis to identify Internet publishers on which to place advertisements for a particular advertiser. In its affinity analysis, the facility first selects one or more Internet publishers that have produced the highest return on investment when presenting advertisements for the advertiser in the past. For each of the selected publishers, the facility identifies one or more “affinity sites”—that is, additional Internet publishers that have been visited by a significant number of the users that have visited the selected publisher. Because the affinity sites are visited by many of the same users that visit the high-performing sites, they are likely to perform similarly well for the advertiser. For this reason, the facility preferably also places advertisements on one or more of the affinity sites.

Tables 5 and 6 below show an example of determining affinity metrics from the advertiser's perspective, between (a) a high return on investment publisher in a previous campaign for the advertiser and (b) other publishers. Table 5 shows a return on investment score for each of the publishers used in an earlier campaign for advertiser Garments.com. These return on investment scores are typically determined based upon, for a set of advertising messages for the advertiser presented on the publisher, factors indicating the level of success of the advertising from the advertiser's perspective, such as: the percentage of such advertisements that were “clicked-through;” the percentage of users that viewed such advertisements that later visited the advertiser's web page; the percentage of users that viewed such an advertising message that purchased something from the advertiser; the average price of items purchased from the advertiser by users that viewed such advertising messages; the average profit margin of items purchased from the advertiser by users that viewed such advertising messages, etc.

TABLE 5
Return on Investment for Earlier Campaign for Garments.com

| Publisher | Return on Investment Score |
|---|---|
| Clothes Horse | 40.1 |
| Entertaining Magazine | 37.6 |
| Just Slacks | 18.3 |
| Handbags Central | 10.6 |
| Shoe Shop | 2.3 |
| Hairstyle Magazine | 1.4 |
| Entertainment This Week | .8 |
| Shop Today | .7 |
| Sailing | .7 |

It can be seen that the Clothes Horse and Entertaining Magazine publishers have significantly higher return on investment scores in the previous campaign than the other publishers. Accordingly, the facility proceeds to identify publishers having a high affinity with the Clothes Horse and Entertaining Magazine publishers.

Table 6 shows the determination of the affinity metric between the high return on investment publisher Clothes Horse and other, “candidate” publishers about which data is available.

TABLE 6
Affinity for High Return on Investment Publisher Clothes Horse

| | unique user | unique | | | |
|---|---|---|---|---|---|
| | identifiers | user | | | |
| | visiting both | identifiers | unique | | |
| | High Return | visiting | user | | |
| | on Investment | High | identifiers | | |
| | Publisher and | Return on | visiting | total | |
| | candidate | Investment | candidate | user | |
| candidate publisher | publisher | Publisher | publisher | identifiers | affinity |
| Cologne Central | 90,000 | 100,000 | 120,000 | 500,000 | 3.750 |
| Hobby Horse | 6,500 | 100,000 | 300,000 | 500,000 | .108 |
| Fashions by Monique | 97,500 | 100,000 | 121,000 | 500,000 | 4.029 |
| Auto Express | 50 | 100,000 | 20,000 | 500,000 | .012 |

The affinity metric, formally stated as:

$$\frac{p \text{(visited candidate publisher} \vert \text{visited high return on investment publisher)}}{p \text{(visited candidate publisher)}}$$

is determined by dividing the product of the number of unique user identifiers visiting both the high return on investment publisher and the candidate publisher and the total number of active user identifiers by the number of users visiting the high return on investment publisher, and further divided by the number of users visiting the candidate publisher.

It can be seen by comparing the affinity scores for the four shown candidate publishers that the Cologne Central and Fashions By Monique publishers have the highest affinities with high return on investment publisher Clothes Horse. Accordingly, the facility preferably selects these two candidate publishers for use in the current advertising campaign for Garments.com.

While embodiments of the facility described above place advertising messages on World Wide Web sites for presentation to users on general-purpose computer systems using Web browsers, additional embodiments of the facility may be used with other communication channels and/or other types of devices. In particular, the facility may preferably be used to place advertising messages delivered to such special-purpose devices as useral digital assistants, cellular and satellite phones, pagers, devices installed in automobiles and other vehicles, automatic teller machines, televisions, and other home appliances.

1. A method in a computing system for assessing, for a selected advertiser and each of a plurality of candidate advertising outlets, a measure of the desirability of placing with the candidate advertising outlet one or more advertising messages for the selected advertiser, comprising, for each of the plurality of candidate advertising outlets:
identifying a plurality of users that have visited the candidate advertising outlet;
counting the number of identified users that have also performed a selected set of actions relative to the selected advertiser; and
generating for the candidate advertising outlet a metric that compares the number of identified users to the number of counted users and constitutes a measure of the desirability of placing with the candidate advertising outlet one or more advertising messages for the selected advertiser.

2. The method of claim 1, further comprising:
analyzing the generated metrics; and
selecting a candidate advertising outlet on which to place one or more advertising messages for the selected advertiser based upon results of the analysis.

3. The method of claim 1 wherein the candidate advertising outlet is a web publisher, and wherein visiting the candidate advertising outlet comprises requesting a page from the web publisher.

4. The method of claim 1 wherein the candidate advertising outlet is a selected portion of a web site, and wherein visiting the candidate advertising outlet comprises requesting a page from the selected portion of the web site.

5. The method of claim 1, further comprising selecting the selected set of actions in response to user input.

6. The method of claim 1 wherein the selected set of actions relative to the selected advertiser are interactions with a web site operated for the selected advertiser.

7. The method of claim 6 wherein the counting is performed based upon a review of a web log generated in serving the web site.

8. The method of claim 1 wherein the selected set of actions relative to the selected advertiser include requests for web pages of a web site operated for the selected advertiser.

9. The method of claim 1 wherein the selected set of actions relative to the selected advertiser include the operation of controls presented on a web site operated for the selected advertiser.

10. The method of claim 1 wherein the selected set of actions relative to the selected advertiser include retrieving information from a web site operated for the selected advertiser.

11. The method of claim 1 wherein the selected set of actions relative to the selected advertiser include ordering items from a web site operated for the selected advertiser.

12. The method of claim 1 wherein the selected set of actions impose an order in which at least a portion of the actions among the set must be perform ed.

13. The method of claim 1 wherein the candidate advertising outlets are web publishers.

14. The method of claim 1 wherein the candidate advertising outlets are Internet publishers.

15. The method of claim 1 wherein the candidate advertising outlets are electronic publishers.

16. The method of claim 1 wherein the metric is generated by dividing the number of counted users by the number of identified users.

17. A computer-readable medium whose contents cause a computing system to assess, for a selected advertiser and each of a plurality of candidate web publishers, a measure of the desirability of placing with the candidate web publisher one or more advertising messages for the selected advertiser by, for each of the plurality of candidate web publishers:
identifying a plurality of users that have visited the web publisher;
counting the number of identified users that have also performed a selected set of actions at a web site operated for the selected advertiser; and
generating for the candidate advertising outlet a metric that compares the number of identified users to the number of counted users and constitutes a measure of the desirability of placing with the candidate web publishers one or more advertising messages for the selected advertiser.

18. A user characterization method performed in a computing system, comprising:
in response to user input, generating a specification of interactions that, when performed by a user on a subject web site, qualify the user as a member of a segment of the subject web site's users; and
storing the generated specification for use in identifying users of the subject web site as members of the segment.

19. The method of claim 18, further comprising:
retrieving the stored specification; and
using the retrieved specification to identify users of the subject web site that are members of the segment.

20. The method of claim 19, further comprising:
counting the number of identified users that have also have visited a candidate advertising outlet; and
generating for the candidate advertising outlet a metric that compares the number of identified users to the number of counted users and constitutes a measure of the desirability of placing with the candidate advertising outlet one or more advertising messages for the subject web site.

21. The method of claim 18 wherein the generated specification specifies interactions in which the user visits a sequence of web pages in a specified order.

22. The method of claim 18 wherein the generated specification specifies interactions in which the user visits one or more specified web pages within a specified time.

23. The method of claim 18 wherein the generated specification specifies interactions in which the user activates one or more visual controls on the subject web site.

24. The method of claim 18 wherein the generated specification specifies interactions in which the user purchases a product on the subject web site.

25. The method of claim 18 wherein the generated specification specifies interactions in which the user purchases at least a minimum number of products on the subject web site.

26. The method of claim 18 wherein the generated specification specifies interactions in which the user purchases at least a minimum total value of products on the subject web site.

27. The method of claim 18 wherein the generated specification specifies interactions not completed by the user on the subject web site.

28. The method of claim 18 wherein the generated specification specifies interactions in which the user selects a product for purchased whose purchase is not completed within a selected period of time.

29. The method of claim 18 wherein the generated specification specifies interactions in which the user visits one or more pages of the subject web site on a specified day.

30. The method of claim 18 wherein the segment in which the generated specification qualifies a user for membership is a segment whose population an operator of the subject web set wishes to expand via advertising.

31. The method of claim 18 wherein the segment in which the generated specification qualifies a user for membership is a segment whose members' behavior an operator of the subject web site wishes to modify via advertising.

32. A user characterization computing system, comprising:
a specification generation subsystem that generates a specification of interactions in response to user input that, when performed by a user on a subject web site, qualify the user as a member of a segment of the subject web site's users; and
a storage device on which the generated specification is stored for use in identifying users of the subject web site as members of the segment.

33. The computing system of claim 32, further comprising a segment membership identification subsystem that retrieves the stored specification from the storage device and uses the retrieved specification to identify users of the subject web site that are members of the segment.

34. One or more computer memories collectively containing an activity specification data structure, comprising one or more indications of actions that must be performed relative to a subject web site in order to perform a selected activity,
such that the contents of the data structure may be compared to actions performed by a particular user to determine whether the user performed the activity with respect to the subject web site,
and such that such determinations may be used to count the number of users performing the selected activity who also visited a selected advertising outlet.

35. One or more computer memories collectively containing an advertising outlet inclination data structure, the data structure containing information indicating, for a selected advertiser having a web page and each of a plurality of candidate advertising outlets, the fraction of visitors to the candidate advertising outlet that also completed a selected sequence of actions relative to the selected advertiser web page,
such that the contents of the data structure may be used to select a candidate advertising outlet on which to place an advertising message for the selected advertiser.

36. A method in a computing system for performing differential advertising for a selected advertiser having a web site, comprising, for each of a plurality of publishers:
identifying a plurality of users that have visited the publisher;
establishing a first count of the number of identified users that have also performed a first set of actions relative to the web site of the selected advertiser, the first set of actions being typically performed by a first segment of users of the web site of the selected advertiser;
establishing a second count of the number of identified users that have also performed a second set of actions relative to the selected advertiser, the second set of actions being typically performed by a second segment of users of the web site of the selected advertiser;
generating for the publisher a first metric that compares the number of identified users to the first count of users and constitutes a measure of the desirability of placing with the publisher an advertising message for the selected advertiser intended for members of the first segment of users; and
generating for the publisher a second metric that compares the number of identified users to the second count of users and constitutes a measure of the desirability of placing with the publisher an advertising message for the selected advertiser intended for members of the second segment of users.

37. The method of claim 36, further comprising:
selecting one or more publishers whose first metrics are the highest for placement of an advertising message intended for members of the first segment of users; and
selecting one or more publishers whose second metrics are the highest for placement of an advertising message intended for members of the second segment of users

38. The method of claim 36, further comprising repeating the establishing and identifying for a third set of actions being typically performed by a third segment of users of the web site of the selected advertiser.

39. The method of claim 36 wherein the first set of actions are purchasing products from the selected advertiser only in a single product category, and wherein the second set of actions are purchasing products from the selected advertiser in multiple product categories.

40. A method in a computing system for assessing, for an advertiser and a selected candidate advertising outlet, a measure of the desirability of placing with the candidate advertising outlet one or more advertising messages for the selected advertiser, comprising:
identifying a set of consumers that have visited the candidate advertising outlet;
selecting consumers among the identified set of consumers to which the advertiser wishes to advertise; and
generating a measure of the usefulness of advertising at the selected candidate advertising outlet by comparing the number of selected consumers to the number of identified consumers.

41. The method of claim 40 wherein generating a measure of the usefulness of advertising at the selected candidate advertising outlet includes dividing the number of selected consumers by the number of identified consumers.

42. The method of claim 40 wherein the method is repeated for each of a plurality of candidate advertising outlets.

43. The method of claim 42, further comprising selecting a candidate advertising outlet among the plurality of candidate advertising outlets having the highest measure.

44. The method of claim 40 wherein consumers among the identified set of consumers are selected if they are known to have visited an outlet of the advertiser.

45. The method of claim 40 wherein consumers among the identified set of consumers are selected if they are known to have visited a web site of the advertiser.

46. The method of claim 40 wherein consumers among the identified set of consumers are selected if they are known to have visited a web presence of the advertiser.

47. The method of claim 40 wherein consumers among the identified set of consumers are selected if they are known to have a history of responding to a certain type of advertising message.

48. The method of claim 40 wherein consumers among the identified set of consumers are selected if they are known to have a selected demographic attribute.

49. The method of claim 40 wherein consumers among the identified set of consumers are selected if they are known to reside in a set of one or more zip codes.

50. The method of claim 40 wherein consumers among the identified set of consumers are selected if they have exhibited a selected web browsing pattern.

51. The method of claim 40 wherein consumers among the identified set of consumers are selected if they have exhibited a selected purchasing pattern.

52. The method of claim 40 wherein the selected customers have visited a portion of a web site corresponding to the selected candidate advertising outlet.

53. A computing system for assessing, for an advertiser and a selected candidate advertising outlet, a measure of the desirability of placing with the candidate advertising outlet one or more advertising messages for the selected advertiser, comprising:
a customer identification subsystem that identifies a set of consumers that have visited the candidate advertising outlet;
a customer selection subsystem that selects consumers among the identified set of consumers to which the advertiser wishes to advertise; and
a rating subsystem that generates a measure of the usefulness of advertising at the selected candidate advertising outlet by comparing the number of selected consumers to the number of identified consumers.

54. A method in a computing system for assessing, for an advertiser and a selected candidate advertising outlet, a measure of the desirability of placing with the candidate advertising outlet one or more advertising messages for the selected advertiser, comprising:
obtaining a first set of person identifiers corresponding to people previously reached by the selected candidate advertising outlet;
obtaining a second set of person identifiers corresponding to people among a target advertising audience for the advertiser; and
generating a measure of the usefulness of advertising at the selected candidate advertising outlet by determining the extent of overlap between the first and second set of person identifiers.

55. The method of claim 54 wherein the method is repeated for each of a plurality of candidate advertising outlets.

56. The method of claim 55, further comprising selecting a candidate advertising outlet among the plurality of candidate advertising outlets having the highest measure.

57. The method of claim 54, further comprising storing each person identifiers obtained among the first or second sets on a computer system corresponding to the person identifier.

58. The method of claim 54 wherein the candidate advertising outlet is a set of one or more web pages, and wherein the obtained first set of person identifiers are person identifiers received for persons visiting one or more of the web pages of the set of web pages.

59. The method of claim 54 the obtained first set of person identifiers correspond to people to whom the advertiser wishes to advertise.

60. The method of claim 54 the obtained first set of person identifiers correspond to people having traits favored by the advertiser.

61. The method of claim 54 the obtained first set of person identifiers correspond to people having demographic traits favored by the advertiser.

62. The method of claim 54 the obtained first set of person identifiers correspond to people having web browsing traits favored by the advertiser.

63. The method of claim 54 the obtained first set of person identifiers correspond to people having purchasing traits favored by the advertiser.

64. The method of claim 54 the obtained first set of person identifiers correspond to people having advertising response traits favored by the advertiser.

65. A computer-readable medium whose contents cause a computing system to assess, for an advertiser and a selected candidate advertising outlet, a measure of the desirability of placing with the candidate advertising outlet one or more advertising messages for the selected advertiser, by:
obtaining a first set of person identifiers corresponding to people previously reached by the selected candidate advertising outlet;
obtaining a second set of person identifiers corresponding to people among a target advertising audience for the advertiser; and
generating a measure of the usefulness of advertising at the selected candidate advertising outlet by determining the extent of overlap between the first and second set of person identifiers.
